(19) United States
(12) Patent Application Publication
(10) Pub. No.: US 2024/0228389 A1
(43) Pub. Date: Jul. 11, 2024

(54) A METHOD FOR PRODUCING CERAMIC TILES, AND CERAMIC TILES

(71) Applicant: Marazzi Group SRL, Sassuolo (IT)

(72) Inventor: Roberto SAMPAOLO, Sassuolo (IT)

(21) Appl. No.: 18/558,712

(22) PCT Filed: Apr. 27, 2022
(86) PCT No.: PCT/IB2022/053888

§ 371 Date: Nov. 2, 2023

(30) Foreign Application Priority Data
May 3, 2021 (IT) 102021000011135

(51) Int. Cl. C04B 41/52; C04B 41/00; C04B 41/45; C04B 41/50; C04B 41/87; C04B 41/89

(52) U.S. Cl. CPC C04B 41/52; C04B 41/0072; C04B 41/009; C04B 41/4545; C04B 41/5031; C04B 41/87; C04B 41/89

(57) ABSTRACT

Method for making a ceramic tile, comprising the steps of providing a raw tile having a body with an upper surface, said body being formed from a ceramic mixture; providing a surface coating on said upper surface of the body, said surface coating comprising refractory particles; firing said raw tile to produce a ceramic tile. The method also comprises a step of brushing the upper surface of the ceramic tile.

### CROSS REFERENCE TO RELATED APPLICATIONS

This application is a filing under 35 U.S.C. 371 of International Application No. PCT/IB2022/053888, filed Apr. 27, 2022, entitled “A METHOD FOR PRODUCING CERAMIC TILES, AND CERAMIC TILES,” which claims priority to Italian Patent Application No. 102021000011135, filed May 3, 2021, which is incorporated herein by reference in its entirety.

### TECHNICAL FIELD

The present invention relates to a method for producing ceramic tiles, and to ceramic tiles, particularly flooring or wall cladding tiles.

### BACKGROUND

Ceramic tiles usually comprise a substantially panel-shaped body of ceramic material, having a decorative surface which may be glazed or unglazed. The surface of the tile may be smooth or structured, or may have a relief pattern.

In the course of private research, the inventors have found that structured surfaces usually have greater slip resistance than smooth surfaces. The inventors have also found in the course of private research that tiles with high slip resistance have a surface that appears particularly rough to the touch, and is therefore uninviting to customers. Indeed, the inventors have observed that customers usually assess a tile, to some extent, by feeling its surface, and tend to choose products with a smoother, or “softer”, surface, rather than products that are safer in terms of slip resistance, unless high slip resistance is expressly required by the specific application of the tile.

EP 2 832 715 describes a tile with high slip resistance and high cleanability, or high ease of cleaning, which comprises a ceramic body and a surface coating formed by a glaze and AZS (alumina-zirconia-silica) particles. EP 2 832 715 does not tackle the problem of improving slip resistance while still providing a surface that is soft to the touch.

In the course of private research, the inventors have also observed that slip resistance depends on the conditions in which said resistance is measured. In particular, the inventors have observed that the same product may have high slip resistance in a first specific condition, for example when the surface is dry and/or walked on with footwear, and limited slip resistance in a second specific condition, for example when the surface is wet and/or walked on with bare feet.

The DIN 51130 standard relates to the measurement of slip resistance with a surface sprinkled with oil and walked on with footwear, while the DIN 51097 standard relates to the measurement of slip resistance with a surface sprinkled with water and walked on with bare feet. In both cases, an operator walks on the surface while the surface is progressively inclined until the operator slips. The standard provides a classification of slip resistance based on the angle of inclination of the surface at which the operator loses friction.

### BRIEF SUMMARY OF THE INVENTION

The present invention proposes, in the first place, to provide an alternative method for producing ceramic tiles, which, according to some of its embodiments, is intended to re-solve one or more of the problems arising from the prior art.

The present invention, according to a first independent aspect thereof, proposes a method for producing a ceramic tile, comprising the steps of providing a raw tile having a body with an upper surface, said body being formed from a ceramic mixture: providing a surface coating on said upper surface of the body, said surface coating comprising refractory particles: and firing said raw tile to produce a ceramic tile, with the characteristic of comprising a step of brushing the upper surface of the ceramic tile.

The inventors have discovered that the addition of refractory particles to the covering coating may impart high slip resistance to the fired tile. This is because said particles, being refractory, do not melt during the firing of the tile, but keep their shape substantially unchanged, making the surface of the tile wrinkled and imparting a high degree of roughness to it. This high surface roughness may correspond to high slip resistance. The brushing of the tile surface enables the main sharp points of the surface to be flattened, at least partially, without changing the overall roughness of the surface. For example, if the surface of the tile is imagined as consisting of peaks and valleys, brushing enables only the higher peaks to be flattened, so that the surface provides a sensation of greater softness to the touch while keeping the performance in terms of slip resistance substantially unchanged. The inventors have also discovered that, by means of brushing, the roughness may become more uniform over the surface of the tile: in other words, smaller differences of height among the peaks can be observed. This greater uniformity in-creases the adaptability of bare feet to the tile surface, and therefore the surface of con-tact with the tile, thus improving slip resistance for bare feet.

According to the preferred embodiment, said brushing is carried out by means of brushes made of polymer material, for example PP. PVC. PA or HDPE, or of metallic material, for example bronze or steel. According to alternative embodiments, said brushes may be made of natural material such as horsehair or tampico. Preferably, said brushes may comprise abrasive material, preferably inorganic, such as mineral, ceramic or glass fillers. In the preferred embodiment, said brushes are made of polymer material filled with abrasive fillers, for example Tynex® (extruded PA with inorganic grit), or of metallic material. In this way, the brushes are capable of abrading the surface of the tile to modify the configuration of the roughness, while being sufficiently flexible to limit the abrasive action to the main sharp points of the roughness of the upper surface.

The brushing is carried out after the firing of the tile.

According to the preferred embodiment, the solid particles may comprise aluminum trihydrate particles. In the course of private research, the inventors have observed that aluminum trihydrate particles, when added to said surface coating, enable high surface roughness to be obtained after firing. As an alternative or in addition to said aluminum trihydrate particles, the solid particles may comprise one or more of the particles selected from the group comprising: aluminates, silicates, zirconates, for example alumina, tabular alumina, zirconium silicate, or alumina-zirconia-silica (AZS). The particles have the characteristic of exhibiting low solubility in the glaze and low fusibility during the firing process, thus remaining in the solid state even in the fired tile, although there is no reason why said particles should not have a degree of reactivity in firing and exhibiting a different form (chemical and/or physical) in the finished product. Moreover, there is no reason why said particles should not act as crystallization nuclei during firing, thus having a larger size than the original in the finished product.

In the preferred embodiment, at least 50% by weight, preferably at least 70%, or even more preferably all, of the particles may be aluminum trihydrate particles.

Preferably, the particles are added to the surface coating in a quantity of less than 10% by weight of the surface coating, preferably less than 7% by weight, or even more preferably less than or equal to 5%. Preferably, the particles are added to the surface coating in a quantity of more than 0.1% by weight of the surface coating, preferably more than 0.5% by weight, or even more preferably 1% or above. The inventors have found that said quantities enable the slip resistance to be maximized without excessively sharpening the roughness of the surface. For example, the quantities indicated make it possible to obtain a slip resistance class of R11 or above according to the DIN 51130 standard and class C (A+B+C) according to the DIN 51097 standard.

The inventors have also discovered that slip resistance for both footwear and bare feet may be maximized if all the particles have a maximum size of less than 40 μm, or preferably less than 35 μm. Additionally, 90% of the particles may have a maximum size of less than 25 μm, or preferably less than 20 μm. 50% of the particles may have a maximum size of less than 15 μm, or preferably less than 10 μm. This is because said particle size enables the particles to form a micro-roughness on the surface of the tile after firing, allowing the slip resistance with a wet surface and bare feet to be maximized (DIN 51097).

The particles may preferably be distributed in a substantially uniform manner over the surface of the tile.

In the preferred embodiment, the surface coating may comprise at least one base layer comprising a glaze and/or an engobe. The base layer may comprise at least one frit and may also comprise one or more ceramic raw materials such as clays, ceramic pigments, whitening agents and opacifiers. According to some embodiments, the surface coating may comprise two base layers, one superimposed on the other, preferably an engobe and a glaze placed on said engobe.

According to the preferred embodiment, said particles may be added to said base layer. If the surface coating comprises a plurality of base layers, the particles may be added to one or more of said base layers. Preferably, the particles are mixed into the glaze before the latter is applied to the surface of the substrate. Advantageously, the base layer may be applied wet, by pouring or airbrushing for example, so as to deposit a substantially uniform layer on the upper surface of the substrate. However, there is no reason why the base layer should not be applied by other methods, for example by digital printing, screen printing or flexography, or by dry application methods. The base layer is preferably colored, for example white, yellow, beige, grey, brown or black.

It should also be noted that the surface coating may comprise a decorative layer having a design. According to the preferred embodiment of the invention, the decorative layer is formed on the base layer. Preferably, the design is printed by digital printing, by inkjet for example, although other printing methods such as screen printing, flexography, off-set and rotogravure are not ruled out. However, inkjet printing and contactless printing methods in general are preferred, because they enable the design to be applied even to highly developed structures. Preferably, the design could represent an imitation of wood, stone, cement, metal or any other design. Preferably, the decorative layer is free of said refractory particles. This is because the inventors have observed that, by applying further layers to the base coating over the layers containing particles, the surface roughness generated by the particles can be slightly flattened, thereby improving the softness of the surface and the slip resistance with bare feet.

In the preferred embodiment, the surface coating may comprise at least one protective layer placed on top of the decorative layer. The protective layer preferably comprises a glaze or a grit. Advantageously, the protective layer may be transparent or translucent. The protective coating is preferably applied wet, by pouring or airbrushing for example, so as to deposit a substantially uniform layer on the upper surface of the tile. There is no reason why the protective coating should not be applied by other methods, for example by digital printing, screen printing or flexography, or by dry application methods. Preferably, the decorative layer is free of said refractory particles. This is because the inventors have observed that, by applying further layers to the base coating over the layers containing particles, the surface roughness generated by the particles can be slightly flattened, thereby improving the softness of the surface and the slip resistance with bare feet. The inventors have also observed that, by placing the particles in layers below the decorative layer and the protective layer, the effect of the particles on the aesthetic characteristics of the product is reduced. The producer of the tiles may therefore offer a choice of products with or without the particles, the addition of the particles making no significant changes to the production process.

According to the preferred embodiment of the first independent aspect, the tile body comprises at least a ceramic mixture suitable for the production, after firing, of a tile of ceramic material such as porcelaneous stoneware, monoporous ceramic, white or red body ceramic, maiolica, or terracotta. The mixture comprises a mix of powders of raw materials such as clay, kaolin, feldspar, quartz, oxides and other minerals.

In the method according to the invention, the tile body may be formed by compacting the mixture by continuous compaction and/or discontinuous pressing. There is no reason why the body should not be produced by extrusion, in less preferred embodiments. According to some embodiments, the compaction of the mixture is carried out with molds and/or compacting belts capable of producing a substantially smooth upper surface of the raw tile. In other embodiments, however, the mold and/or the compacting belt could comprise a structure that is the negative of the structure to be produced on the upper surface of the body.

Preferably, the method may comprise a drying step, to eliminate at least some of any residual moisture from the mixture, and to impart greater mechanical strength to the raw tile. The drying is preferably carried out at temperatures above 80° C., for example above 100° C. The drying is carried out after the pressing step, and may preferably be carried out before the step of applying the surface coating. Preferably, the raw tile after drying has a residual moisture content of less than 5%, or preferably less than 1%.

The method also comprises the step of firing the tile at a temperature of more than 900° C., or preferably more than 1000° C., for example about 1200° C. The firing step follows the step of providing the surface coating and precedes said brushing step.

The method may also comprise a step of grinding the tile, which may precede or follow the brushing step.

It should be noted that the fact that said particles are present in the base layer of the protective coating and that said base layer is placed below a decorative layer represents an inventive concept which is independent of the fact that the method provides for brushing the surface. In fact, the inventors have observed that, by applying further layers over the layers containing particles, the surface roughness generated by the particles can be slightly flattened, thereby improving the softness of the surface and the slip resistance with bare feet. Therefore, a second independent aspect of the invention provides a method for producing a ceramic tile, comprising the steps of providing a raw tile having a body with an upper surface, said body being formed from a ceramic mixture: providing a surface coating on said upper surface of the body, said surface coating comprising refractory particles: and firing said raw tile to produce a ceramic tile, with the characteristic that the surface coating comprises at least one base layer and at least one decorative layer and/or a protective layer placed above said base layer, and in which said particles are placed in said base layer. Furthermore, a third independent aspect provides a ceramic tile comprising a body of ceramic material with an upper surface and a surface coating capable of covering at least said upper surface of the body, said surface coating comprising refractory particles, with the characteristic that the surface coating comprises at least one base layer and at least one decorative layer and/or a protective layer placed above said base layer, and in which said particles are placed in said base layer.

The method according to the second independent aspect and the tile according to the third independent aspect of the invention may comprise one or more of the characteristics described in relation to the first independent aspect.

### BRIEF DESCRIPTION OF THE DRAWINGS

With the intention of better showing the characteristics and advantages of the invention, in the following, as an example without any limitative character, several preferred forms of embodiments are described with reference to the accompanying drawings, wherein:

FIG. 1 is an axonometric view of a tile produced by the method according to the invention;

FIG. 2 is an enlargement of the cross section taken along the plane II-II of FIG. 1;

FIG. 3 is an enlargement of the area III of FIG. 2;

FIG. 4 shows schematically a production line and some procedures of a method according to a first possible implementation of the invention.

### DETAILED DESCRIPTION OF THE INVENTION

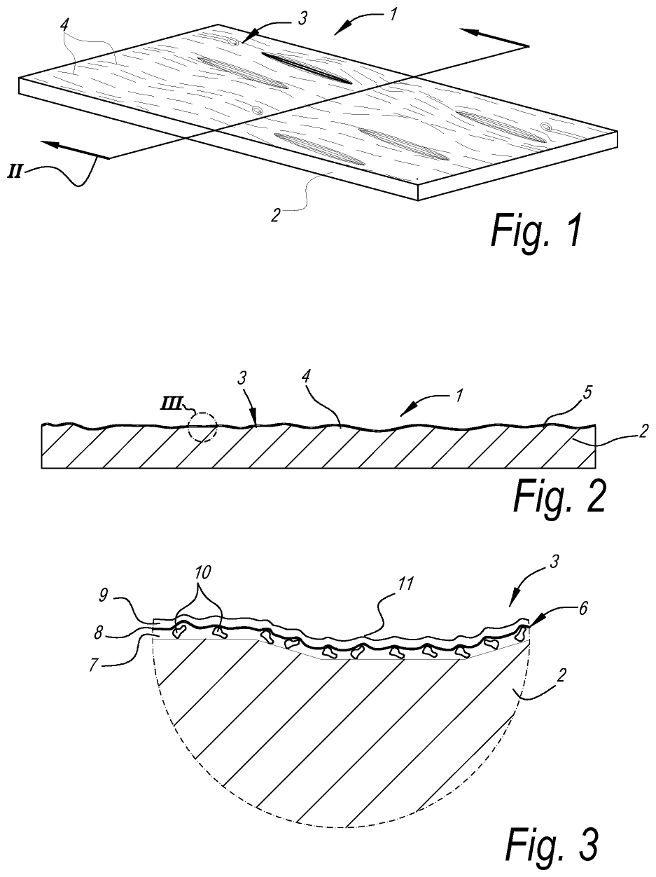

FIG. 1 shows a ceramic tile 1 comprising a body 2 of ceramic material, porcelaneous stoneware for example, and an upper surface 3 having a design 4, representing wood or stone for example.

As shown in FIG. 2, the tile 1 comprises a relief structure 5 formed in said body 2 and apparent on the upper surface 3. The relief structure 5 may represent the grain of wood or natural stone, and may have structural characteristics, such as recesses or protrusions, corresponding to characteristics of the design 4.

FIG. 3 shows that the tile 1 further comprises a surface coating 6 capable of covering an upper surface of the body 2. The surface coating 6 comprises a base layer 7, a glaze for example, placed on the upper surface of the body 2.

The surface coating 6 further comprises a decorative layer 8 in which the design 4 placed above the base layer 7 is at least partially formed. The design 4 is preferably formed by digital printing. The surface coating 6 further comprises a protective layer 9, preferably transparent or translucent, placed above the decorative layer 8. The protective layer preferably comprises a transparent glaze.

As shown in FIG. 3, the protective coating 6 comprises particles 10 placed mainly in the base layer. The particles 10 preferably form between 1% and 5% by weight of the base layer 7. In the preferred embodiment, at least 70% by weight of the particles, or preferably all of the particles, are aluminum trihydrate particles.

In the illustrated example, all the particles have a maximum size of less than 40 μm, or preferably less than 35 μm. Additionally, 90% of the particles have a maximum size of less than 25 μm, or preferably less than 20 μm. 50% of the particles have a maximum size of less than 15 μm, or preferably less than 10 μm.

As shown in FIG. 3, the particles 10 cause the formation of a surface roughness 11 on the upper surface 3 of the tile, enabling the slip resistance to be improved, particularly for bare feet. As shown in FIG. 3, the layers placed above the base layer 7 which contains particles 10 enable the roughness generated by the particles 10 to be partially flattened, so as to improve the response to touch. Additionally, a pronounced but gentler roughness 11 promotes the adaptation of bare feet to the upper surface 3 of the tile 1, so as to improve slip resistance for bare feet. This effect of softening the roughness 11 is also obtained as a result of brushing the surface.

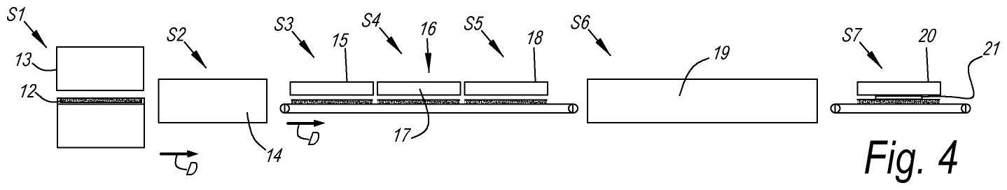

FIG. 4 shows some steps of a method for producing the tile 1 of FIG. 1, according to a first possibility of the first independent aspect of the invention.

The method comprises a step S1 of forming a raw tile 12, which in this step is substantially defined by the body 2, by compacting powders of a ceramic mixture. In practice, in a compaction station 13 the powders are compacted, by means of a discontinuous press in the example, so as to impart a substantially panel-like shape to the body 2.

The body 2 advances along the line in a direction of advance D towards a drier 14 for removing moisture from the mixture of the body 2 in a drying step S2.

The body 2 advances in the direction D towards a coating station 15 in which, by means of a first coating procedure S3, the raw tile 12 is provided with the base layer 6, by means of airless spraying or airbrushing, or by pouring, for example. During the first coating procedure S3, the particles 10 are placed on the surface of the raw tile 12 together with the base layer 7.

The coated raw tile 12 advances towards a decorating station 16 having an inkjet printer 17, in which the raw tile 12 is provided with the design 4 by a printing step S4. The raw tile 12, now decorated, advances towards a second coating station 18 in which, by means of a second coating procedure S5, the raw tile 12 is provided with the protective coating 9, by means of airless spraying or airbrushing for example.

The raw tile 12 is then subjected to a firing step S6 in a kiln 19, for example a continuous roller kiln, at a maximum temperature of approximately 1200° C., so as to produce the tile 1.

After the firing step S6, the tile 1 is subjected to a step S7 of brushing the upper surface 3 of the tile 1, in a brushing machine 20, so as to flatten sharp areas of the roughness 11, making the surface softer to the touch and improving the performance in terms of slip resistance for bare feet.

The brushing S7 is preferably carried out by means of brushes made of polymer material filled with abrasive fillers, for example Tynex® (extruded PA with inorganic grit).

The invention thus conceived is susceptible of numerous modifications and variations, all of which fall within the scope of the inventive concept.

Furthermore, all the details may be replaced with other technically equivalent elements. In practice, the materials used, as well as the contingent shapes and dimensions, may be any, according to requirements, without thereby departing from the protective scope of the following claims.

1-15. (canceled)

16. Method for making a ceramic tile, comprising the steps of providing a raw tile having a body with an upper surface, said body being formed from a ceramic mixture; providing a surface coating on said upper surface of the body, said surface coating comprising refractory particles; and firing said raw tile to produce a ceramic tile, wherein it comprises a step of brushing the upper surface of the ceramic tile.

17. Method according to claim 16, wherein said brushing is carried out by means of brushes made of polymer material or metallic material.

18. Method according to claim 16, wherein said brushes may comprise abrasive material.

19. Method according to claim 16, wherein the brushing is carried out after the firing of the tile.

20. Method according to claim 16, wherein said particles comprise aluminum trihydrate particles.

21. Method according to claim 16, wherein said particles are added to the surface coating in a quantity of between 1% and 5% by weight of the surface coating.

22. Method according to claim 16, wherein the surface coating comprises a base layer and a decorative layer placed on said base layer.

23. Method according to claim 22, wherein said particles are added into said base layer.

24. Method according to claim 22, wherein the surface coating comprises a protective layer above said decorative layer.

25. Method according to claim 24, wherein said protective layer is free of said particles.

26. Ceramic tile having a body with an upper surface and a surface coating of said upper surface, in which said surface coating comprises refractory particles, wherein said surface coating comprises a base layer and a decorative layer placed on said base layer, and in which said particles are placed in said base layer.

27. Tile according to claim 26, wherein the surface coating comprises a protective layer above said decorative layer.

28. Tile according to claim 27, wherein said protective layer is free of said particles.

29. Tile according to claim 26, wherein said particles comprise aluminum trihydrate particles.

30. Tile according to claim 26, wherein said particles are present in said surface coating in a quantity of between 1% and 5% by weight of the surface coating.
